(19) United States
(12) Patent Application Publication
(10) Pub. No.: US 2021/0157161 A1
(43) Pub. Date: May 27, 2021

(54) OPTICAL SHEET, LASER PROJECTION MODULE, DEPTH CAMERA, AND ELECTRONIC DEVICE USING SAME

(71) Applicant: TRIPLE WIN TECHNOLOGY(SHENZHEN) CO.LTD., Shenzhen (CN)

(72) Inventor: CHENG-DONG WANG, Shenzhen (CN)

(21) Appl. No.: 16/929,362

(22) Filed: Jul. 15, 2020

(30) Foreign Application Priority Data
Nov. 21, 2019 (CN) 201911148947.6

(51) Int. Cl. G02B 27/42; G02B 1/14; G02B 27/30; G01B 11/22

(52) U.S. Cl. CPC G02B 27/425; G01B 11/22; G02B 27/30; G02B 1/14

(57) ABSTRACT

An optical sheet includes a substrate, a protective structure on a surface of the substrate, and an optical diffraction structure on a side of the substrate opposite to the surface. The substrate is made of a transparent material and defines a projection area and a non-projection area surrounding the projection area. The protective structure includes a metal circuit in the non-projection area and surrounding the projection area. The optical diffraction structure is configured to diffract light.

### FIELD

The subject matter herein generally relates to a technical field of optical sensing and identification, in particular to an optical sheet, a laser projection module having the optical sheet, a depth camera having the optical sheet, and an electronic device having the optical sheet.

### BACKGROUND

Where the light source of a projection device is laser, a common protection method for safety is to form an indium tin oxide film on a surface of an optical diffractive element substrate, and then electrically connect the indium tin oxide film to a controlling integrated circuit. The controlling integrated circuit is communicatively connected to the laser source. If the optical diffractive element substrate cracks, the indium tin oxide film coated on it will also crack. At such time, the controlling integrated circuit will detect a resistance change of the indium tin oxide film. When the resistance of the indium tin oxide film is greater than a preset resistance threshold, the laser source is turned off to prevent the laser from outputting laser light into the surrounding environment through the crack. However, due to the limitation of the production process (such as physical vacuum depositing) of indium tin oxide film, achieving an identical and precise value of resistance for all indium tin oxide films formed in different batches or in the same batch is very difficult. The resistance of these indium tin oxide films usually fluctuates within a certain range. Therefore, when the optical diffractive element substrate cracks, the resistance of the indium tin oxide film on different portions of the optical diffractive element substrate is different. The preset resistance threshold used to detect the crack is a fixed value, so there may be a situation where the resistance of the optical diffractive element substrate after rupture is not obvious relative to the preset resistance threshold, which may cause the controlling integrated circuit to fail in detecting the variations, so the laser source can emit a laser beam directly outwards into the surrounding environment, which is harmful. Therefore, there is room for improvement in the art.

### BRIEF DESCRIPTION OF THE DRAWINGS

Implementations of the present technology will now be described, by way of embodiments only, with reference to the attached figures.

FIG. 1A is a planar view of an optical sheet according to a first embodiment of the present disclosure.

FIG. 1B is a planar view of an optical sheet in another embodiment.

FIG. 1C is a planar view of an optical sheet in another embodiment.

FIG. 2 is a cross-sectional view of the optical sheet.

FIG. 3 is a planar view of an optical sheet according to a second embodiment of the present disclosure.

FIG. 4 is a view showing the optical sheet of FIG. 3 coupled to a controlling circuit.

FIG. 5 is a schematic view of a laser projection module.

FIG. 6 is a cross-sectional view of the laser projection module of FIG. 5.

FIG. 7 is a schematic view of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

### FIRST EMBODIMENT

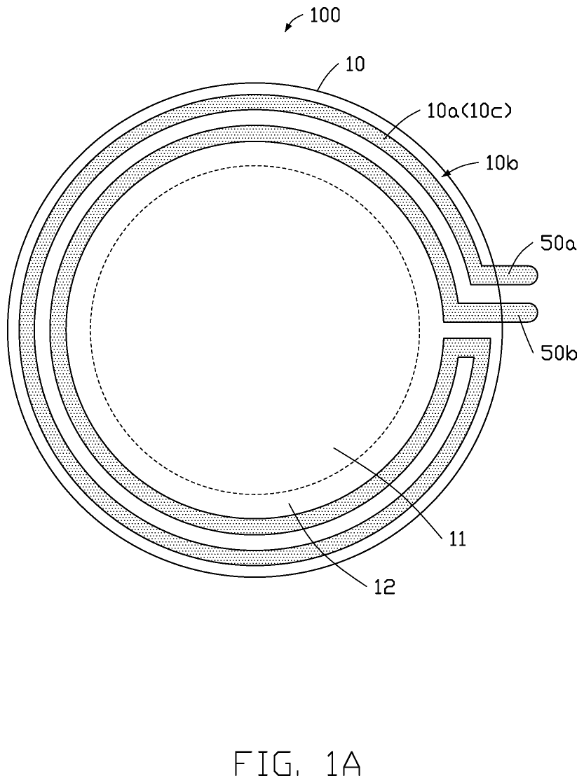

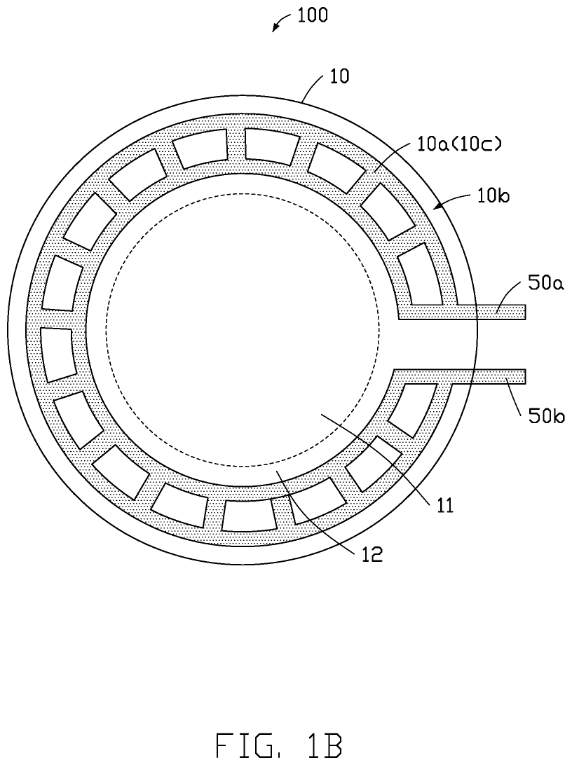

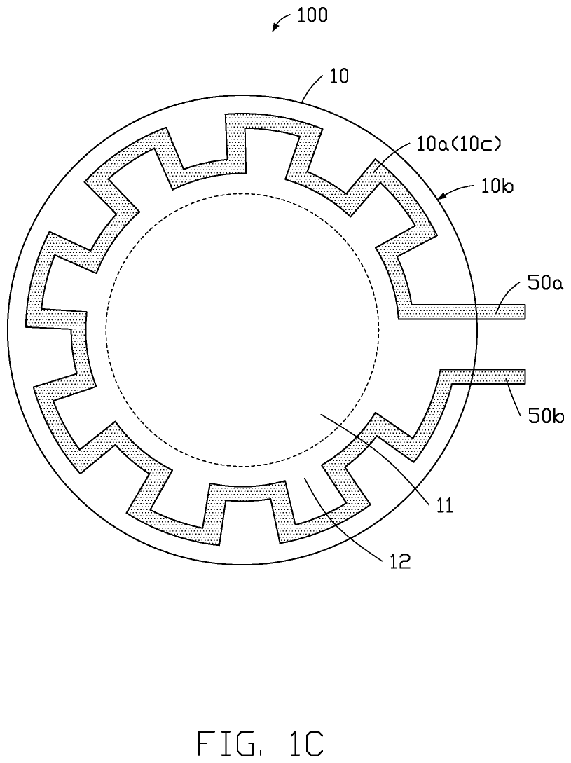

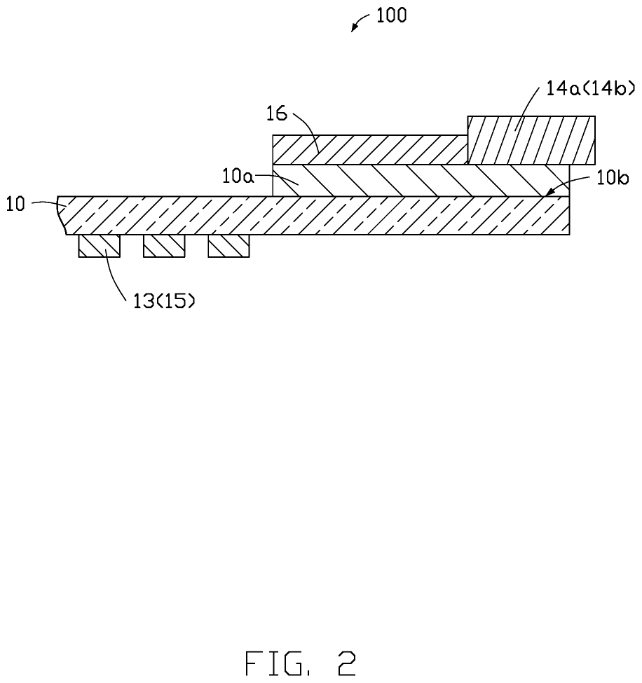

FIG. 1A illustrates an optical sheet 100 of a first embodiment. The optical sheet 100 includes a substrate 10 and a protective structure 10a on the substrate 10. The optical sheet 100 is at least translucent, light can pass through the optical sheet 100. The substrate 10 defines a projection area 11 and a non-projection area 12 surrounding the projection area 11. The protective structure 10a is formed on a surface 10b of the substrate 10. The protective structure 10a includes a metal circuit 10c in the non-projection area 12. The metal circuit 10c surrounds the projection area 11. As shown in FIG. 2, an optical diffraction structure 13 is formed on a side of the substrate 10 opposite to the surface 10b. The optical diffraction structure 13 is configured to diffract light passing through.

The substrate 10 may be made of a transparent material, such as inorganic glass, transparent plastic, composite material, and polyester.

Referring to FIG. 1A, the metal circuit 10c in this embodiment includes a first input terminal 50a and a first output terminal 50b. The first input terminal 50a faces the first output terminal 50b. The metal circuit 10c extends from the first input terminal 50a toward the first output terminal 50b in the non-projection area 12. When the metal circuit 10c is connected to an external circuit (not shown) by the first input terminal 50a and the first output terminal 50b, a first circuit is formed. The metal circuit 10c has an annular shape between the first input terminal 50a and the first output terminal 50b.

In other embodiments, the metal circuit 10c between the first input terminal 50a and the first output terminal 50b may have other more complicated regular or irregular shapes. As shown in FIG. 1B, in a modification, the metal circuit 10c may have a shape of a tooth. As shown in FIG. 1C, the metal circuit 10c may be ladder-like in shape. The two metal circuits 10c shown in FIG. 1B and FIG. 1C are more complicated and delicate than the metal circuit 10c in FIG. 1A.

Referring to FIG. 2, a transparent protective film 16 is formed on a side of the metal circuit 10c away from the substrate 10. The protective film 16 may be made of an electrically insulating material and is configured to protect the metal circuit 10c. Two first connection pads 14a are provided on the edge of the metal circuit 10c. One of the two first connection pads 14a is connected to the first input terminal 50a and the other one of the two first connection pads 14a is connected to the first output terminal 50b.

The optical diffraction structure 13 on the side of the substrate 10 opposite to the surface 10b is formed by forming a transparent silicon dioxide film 15 on the side of the substrate 10 opposite to the surface 10b and etching the silicon dioxide film 15.

When the light source is not a laser source, the metal circuit 10c may be in the projection area 11 or the non-projection area 12.

### SECOND EMBODIMENT

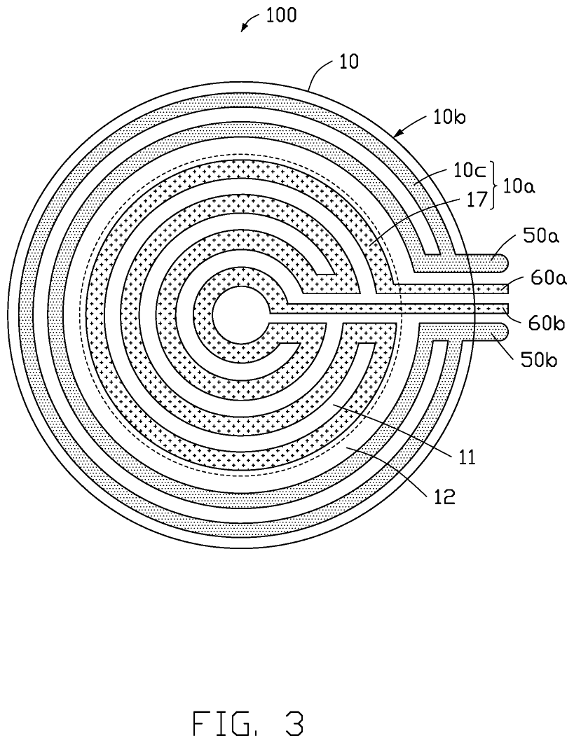

FIG. 3 illustrates an optical sheet 100 of a second embodiment. The protective structure 10a of the optical sheet 100 not only includes the metal circuit 10c in the non-projection area 12, but also includes a transparent conductive film 17 in the projection area 11. The transparent conductive film 17 is made of a transparent conductive metal oxide. In this embodiment, the metal oxide is indium tin oxide. Both the transparent conductive film 17 and the metal circuit 10c partially cover the surface 10b of the substrate 10.

As shown in FIG. 3, the transparent conductive film 17 includes a second input terminal 60a and a second output terminal 60b. When the transparent conductive film 17 is connected to an external circuit by both the second input terminal 60a and the second output terminal 60b, a second circuit can be formed. The second circuit and the first circuit are independent from each other.

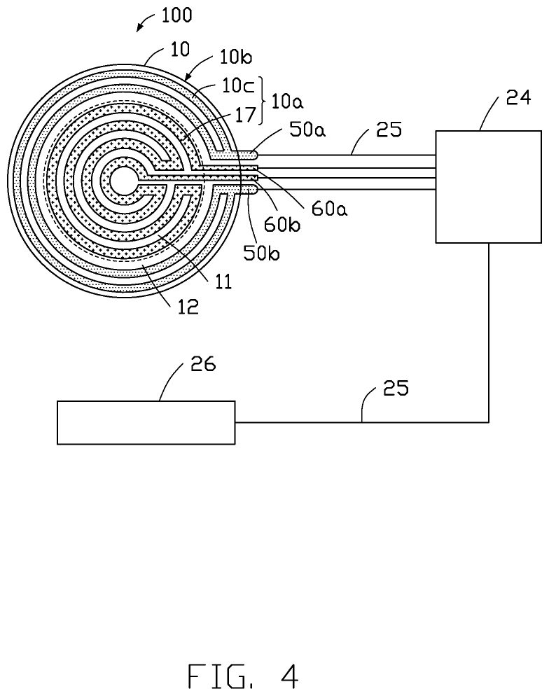

As shown in FIG. 4, the metal circuit 10c of the protective structure 10a is electrically coupled to a controlling integrated circuit 24 by wires 25; and the transparent conductive film 17 of the protective structure 10a is electrically coupled to the controlling integrated circuit 24 by wires 25. If the non-projection area 12 of the substrate 10 is slightly damaged, the resistance of the metal circuit 10c changes, such change is immediately detected by the controlling integrated circuit 24. If the substrate 10 is slightly damaged in the projection area 11, the resistance of the transparent conductive film 17 changes, such change is detected by the controlling integrated circuit 24. When the controlling integrated circuit 24 detects an abnormality in any part of the optical sheet 100, the controlling integrated circuit 24 can turn off a laser source to protect the surrounding environment from the laser. When a crack occurs in the optical sheet 100, the crack is usually at an edge of the optical sheet 100, that is, in the non-projection area 12.

The density of the metal circuit 10c distributed on the substrate 10 can be adjusted according to a size of the substrate 10. The thinner the line width of the metal circuit 10c and the more complicated the metal circuit 10c, the more sensitive the controlling integrated circuit 24 will be in detecting changes in the optical sheet 100.

The optical sheet 100 described in this disclosure is an optical diffractive element. Compared to a conventional optical sheet in which the surface of the substrate is only the indium tin oxide film, the optical sheet 100 in this disclosure can be integrated into a smaller-sized substrate 10, more suitable for miniaturization of devices. When an abnormality occurs in any part of the optical sheet 100, the abnormality can be detected by an external control circuit and the laser source can be turned off.

In particular, if the light source is a laser source, the metal circuit 10c cannot be positioned in the projection area 11.

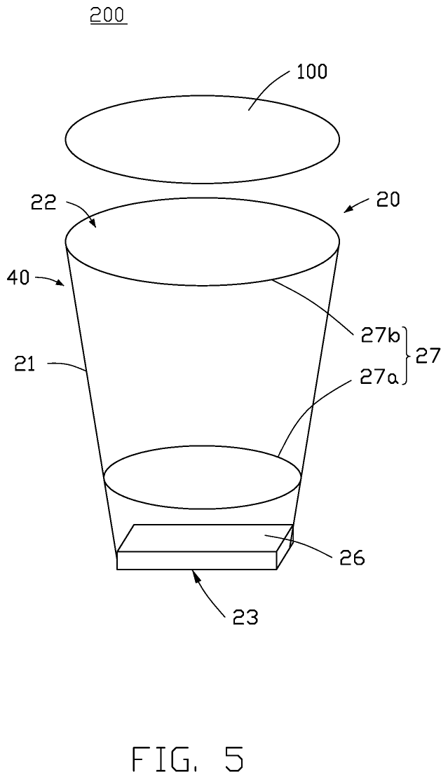

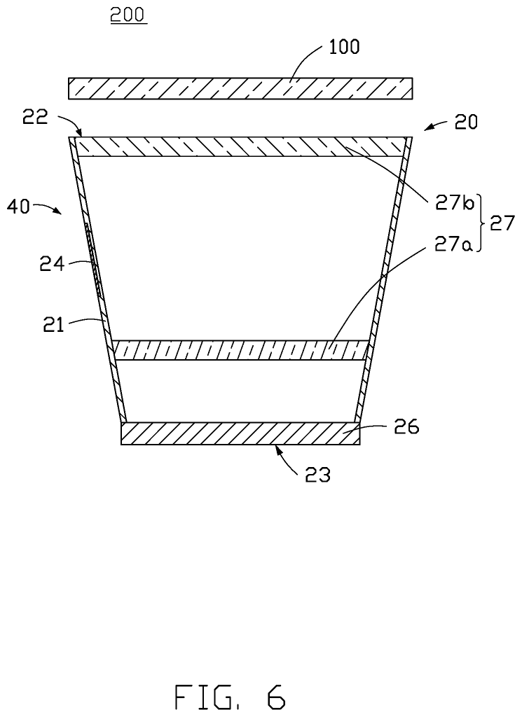

FIG. 5 and FIG. 6 illustrate a laser projection module 200. The laser projection module 200 includes a laser emitter 26, the optical sheet 100, and the controlling integrated circuit 24. The laser emitter 26 is a vertical-cavity surface emitting laser, and the laser emitter 26 is configured to emit laser beams. The optical sheet 100 converts the laser emitted from the laser emitter 26 into a diffracted laser pattern. The controlling integrated circuit 24 is electrically connected to the metal circuit 10c of the optical sheet 100 and communicatively connected to the laser emitter 26. The controlling integrated circuit 24 detects any resistance variation of the metal circuit 10c, and controls the laser emitter 26 to be turned off when the resistance variation of the metal circuit 10c exceeds a preset threshold.

The laser projection module 200 further includes a lens holder 20. The controlling integrated circuit 24 may be installed on a side wall 21 of the lens holder 20. A portion of wires 25 may be embedded in the side wall 21 of the lens holder 20. The lens holder 20 is hollow and includes a bottom 23. An opening 22 is defined on a side of the lens holder 20 opposite to the bottom 23. The laser emitter 26 is positioned at the bottom 23 of the lens holder 20 and emits laser toward the opening 22 of the lens holder 20.

The laser projection module 200 further includes a collimating beam expander 27 between the laser emitter 26 and the optical sheet 100. The collimating beam expander 27 is positioned in the lens holder 20. The collimating beam expander 27 includes a concave lens 27a and a convex lens 27b both configured to collimate the laser emitted from the laser emitter 26. The concave lens 27a and the convex lens 27b are opposite to and spaced apart from each other. In this embodiment, the concave lens 27a is between the laser emitter 26 and the convex lens 27b; the convex lens 27b is between the concave lens 27a and the optical sheet 100. The convex lens 27b closes the opening 22. The concave lens 27a is configured to cause divergence of the laser emitted from the laser emitter 26, and the convex lens 27b is configured to collimate the laser after being diverged by the concave lens 27a so as to emit a parallel wide-beam laser light.

In this embodiment, after the wide-beam laser passes through the optical diffraction structure 13 of the optical sheet 100, a diffracted laser pattern is formed in a predetermined area. When any portion of the entire area of the optical sheet 100 is damaged, the controlling integrated circuit 24 can immediately detect the change in the resistance value of the optical sheet 100, and then quickly control the laser emitter 26 to be powered off by the wire 25. The laser projection module 200 described in this embodiment effectively improves safety and avoids the laser beam directly escaping into the surrounding environment when the optical sheet 100 is damaged.

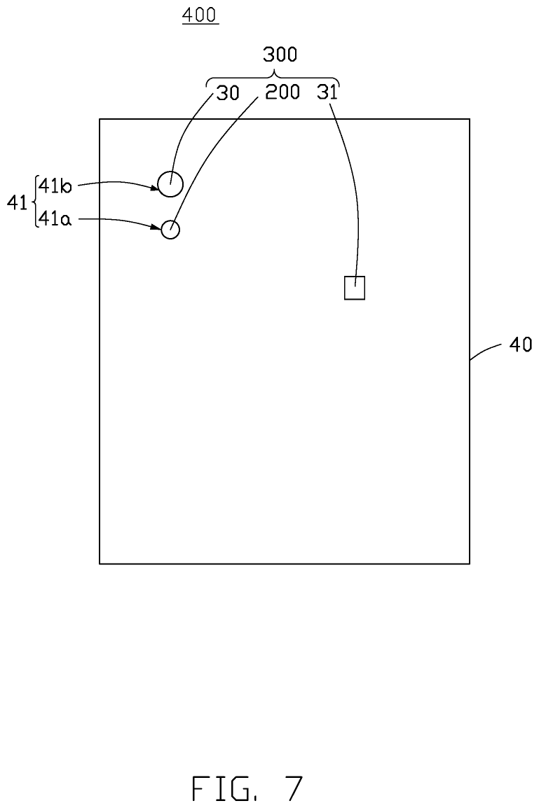

FIG. 7 illustrates an electronic device 400. The electronic device 400 includes a housing 40 and a depth camera 300 installed in the housing 40. The housing 40 includes a light-transmitting area 41. The light-transmitting area 41 includes a first light-transmitting area 41a and a second light-transmitting area 41b spaced apart from the first light-transmitting area 41a. The depth camera 300 includes the above described laser projection module 200, a receiver 30, and a processor 31. The receiver 30 is configured to receive the diffracted laser pattern projected by the laser projection module 200 in a predetermined area. The processor 31 is configured to process the diffracted laser pattern received by the receiver 30 to obtain a depth image.

The laser projection module 200 and the receiver 30 are positioned corresponding to and aligning with the light-transmitting area 41. In this embodiment, the laser projection module 200 is positioned corresponding to and aligning with the first light-transmitting area 41a; the receiver 30 is positioned corresponding to and aligning with the second light-transmitting area 41b. The light-transmitting area 41 may be a hole extending through the housing 40 or the site of a transparent material on the housing 40.

Laser light is emitted from the first light-transmitting area 41a to the outside of the electronic device 400. The receiver 30 acquires the laser pattern projected by the laser on the predetermined area by the second light-transmitting area 41b.

Since the wires 25 in the laser projection module 200 can be partially embedded in the lens holder 20, the laser projection module 200 can be miniaturized, for overall miniaturization of the depth camera 300.

The electronic device 400 can be, but is not limited to, a mobile phone, a tablet computer, or an access control or other electronic device with shooting functions.

The metal circuit 10c is formed on the surface 10b of the substrate 10, and the controlling integrated circuit 24 detects the resistance change of the metal circuit 10c before and after the metal circuit 10c is broken. In additional, the metal circuit 10c can be integrated into the smaller substrate 10. Unlike the traditional indium tin oxide, significant miniaturization of devices can be achieved. Compared to the indium tin oxide, the metal circuit 10c has greatly reduced cost and is useful in many applications.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. An optical sheet capable of allowing light to pass through, comprising:
a substrate, the substrate made of a transparent material and defining a projection area and a non-projection area surrounding the projection area;
a protective structure on a surface of the substrate, the protective structure comprising a metal circuit in the non-projection area and surrounding the projection area; and
an optical diffraction structure on a side of the substrate opposite to the surface, the optical diffraction structure configured to diffract the light.

2. The optical sheet of claim 1, wherein the metal circuit comprises a first input terminal and a first output terminal; the first input terminal is opposite to the first output terminal; the metal circuit extends from the first input terminal toward the first output terminal in the non-projection area to surround the projection area.

3. The optical sheet of claim 1, wherein the optical diffraction structure is a silicon dioxide film.

4. The optical sheet of claim 1, wherein a transparent protective film is on a side of the metal circuit away from the substrate; the transparent protective film is made of an electrically insulative material and configured to protect the metal circuit.

5. The optical sheet of claim 1, wherein the protective structure further comprises a transparent conductive film in the projection area, the transparent conductive film is on the surface of the substrate.

6. The optical sheet of claim 5, wherein the transparent conductive film comprises a second input terminal and a second output terminal.

7. A laser projection module, comprising:
a laser emitter configured to emit laser beams;
an optical sheet configured to convert the laser beams from the laser emitter into a diffracted laser pattern, the optical sheet comprising:
a substrate, the substrate made of a transparent material and defining a projection area and a non-projection area surrounding the projection area;
a protective structure on a surface of the substrate, the protective structure comprising a metal circuit in the non-projection area and surrounding the projection area; and
an optical diffraction structure on a side of the substrate opposite to the surface, the optical diffraction structure configured to diffract the laser beams; and
a controlling integrated circuit electrically connected to the metal circuit and communicatively connected to the laser emitter, the controlling integrated circuit configured to detect the resistance variation of the metal circuit and control the laser emitter to be turned off when the resistance variation of the metal circuit exceeds a preset threshold.

8. The laser projection module of claim 7, further comprising a collimating beam expander between the laser emitter and the optical sheet.

9. The laser projection module of claim 8, wherein the collimating beam expander comprises a concave lens and a convex lens opposite to each other and spaced apart from each other; the concave lens is between the laser emitter and the convex lens; the convex lens is between the concave lens and the optical sheet.

10. The laser projection module of claim 7, wherein the metal circuit comprises a first input terminal and a first output terminal; the first input terminal faces the first output terminal; the metal circuit extends from the first input terminal toward the first output terminal in the non-projection area to surround the projection area; the first input terminal and the first output terminal are electrically coupled to the controlling integrated circuit.

11. The laser projection module of claim 7, wherein the optical diffraction structure is a silicon dioxide film.

12. The laser projection module of claim 7, wherein a transparent protective film is on a side of the metal circuit away from the substrate; the transparent protective film is made of an electrically insulative material and configured to protect the metal circuit.

13. The laser projection module of claim 7, wherein the protective structure further comprises a transparent conductive film in the projection area, the transparent conductive film is on the surface of the substrate.

14. The laser projection module of claim 13, wherein the transparent conductive film comprises a second input terminal and a second output terminal; the second input terminal and the second output terminal are electrically coupled to the controlling integrated circuit.

15. A depth camera, comprising:
a laser projection module, the laser projection module comprising:
a laser emitter configured to emit laser beams;
an optical sheet configured to convert the laser beams from the laser emitter into a diffracted laser pattern, the optical sheet comprising:
a substrate, the substrate made of a transparent material and defining a projection area and a non-projection area surrounding the projection area;
a protective structure on a surface of the substrate, the protective structure comprising a metal circuit in the non-projection area and surrounding the projection area; and
an optical diffraction structure on a side of the substrate opposite to the surface, the optical diffraction structure configured to diffract the laser beams; and
a controlling integrated circuit electrically connected to the metal circuit and communicatively connected to the laser emitter, the controlling integrated circuit configured to detect the resistance variation of the metal circuit and control the laser emitter to be turned off when the resistance variation of the metal circuit exceeds a preset threshold;
a receiver configured to receive the diffracted laser pattern projected by the laser projection module in a predetermined area; and
a processor configured to process the diffracted laser pattern received by the receiver to obtain a corresponding depth image.

16. The depth camera of claim 15, wherein the laser projection module further comprises a collimating beam expander between the laser emitter and the optical sheet; the collimating beam expander comprises a concave lens and a convex lens opposite to each other and spaced apart from each other; the concave lens is between the laser emitter and the convex lens; the convex lens is between the concave lens and the optical sheet.

17. The depth camera of claim 15, wherein the metal circuit comprises a first input terminal and a first output terminal; the first input terminal faces the first output terminal; the metal circuit extends from the first input terminal toward the first output terminal in the non-projection area to surround the projection area; the first input terminal and the first output terminal are electrically coupled to the controlling integrated circuit.

18. The depth camera of claim 15, wherein the optical diffraction structure is a silicon dioxide film.

19. The depth camera of claim 15, wherein the protective structure further comprises a transparent conductive film in the projection area, the transparent conductive film is on the surface of the substrate; the transparent conductive film comprises a second input terminal and a second output terminal; the second input terminal and the second output terminal are electrically coupled to the controlling integrated circuit.

20. An electronic device, comprising:
a housing, the housing defining a light-transmitting area; and
the depth camera of claim 1 in the housing, the laser projection module and the receiver positioned corresponding to and aligning with the light-transmitting area.
